(19) United States
(12) Patent Application Publication
(10) Pub. No.: US 2024/0086918 A1
(43) Pub. Date: Mar. 14, 2024

(54) DECENTRALIZED IDENTITY VERIFICATION FOR PAYMENT TRANSACTIONS

(71) Applicant: Discover Financial Services, Riverwoods, IL (US)

(72) Inventors: Daniel A. Gisolfi, Hopewell Junction, NY (US); Daniel Sadler, South Jordan, UT (US); Eoin Flannery, Hawthorn Woods, IL (US)

(21) Appl. No.: 17/942,872

(22) Filed: Sep. 12, 2022

(51) Int. Cl. G06Q 20/40; G06Q 20/38; H04L 9/08; H04L 9/32

(52) U.S. Cl. CPC G06Q 20/4014; G06Q 20/3821; G06Q 20/3829; G06Q 20/387; H04L 9/0825; H04L 9/3271

(57) ABSTRACT

A client device is configured to (i) receive, from a credential issuer, a digital credential including (a) an identifier for the credential issuer and (b) credential information indicating an identity of a user associated with the client device, (ii) cause the digital credential to be maintained in storage, (iii) receive, from a credential verifier, an authentication challenge associated with a payment instrument, the authentication challenge including (a) an identifier for the credential verifier and (b) a request for credential information indicating the identity of the user of the payment instrument, where the request is encrypted using a private key of the credential verifier, (iv) use the identifier for the credential verifier to obtain a public key of the credential verifier, (v) use the public key to decrypt the encrypted request, and (vi) based on the decrypted request, transmit an authentication challenge response including the digital credential to the credential verifier.

### BACKGROUND

Verification of a cardholder's identity to authenticate a credit card transaction is an important task that can help to reduce the incidence of commercial fraud. In this regard, verification of a cardholder's identity generally involves a verification by a merchant that the consumer presenting the credit card for payment is the correct holder to whom the credit card was issued.

### OVERVIEW

Disclosed herein is new technology that facilitates applying pre-authorization authentication and consumer identity verification measures to an online payment transaction.

In one aspect, the disclosed technology may take the form of a method to be carried out by a computing platform that involves (i) receiving, from a credential issuer that has verified an identify of a user associated with the client device, a digital credential comprising (a) an identifier for the credential issuer and (b) encrypted credential information indicating the identity of the user, wherein the credential information is encrypted using a private key of the credential issuer, (ii) causing the digital credential to be maintained in storage on the client device, (iii) receiving, from a computing platform associated with a credential verifier, an authentication challenge associated with a payment using a payment instrument, wherein the authentication challenge comprises (a) an identifier for the credential verifier and (b) an encrypted request for credential information indicating the identity of the user of the payment instrument, wherein the request is encrypted using a private key of the credential verifier, (iv) using the identifier for the credential verifier to obtain a public key of the credential verifier, (v) using the public key of the credential verifier to decrypt the encrypted request, and (vi) based on the decrypted request, transmitting an authentication challenge response comprising the digital credential to the computing platform.

In some example embodiments, the client device is a second client device and the received authentication challenge is embodied by a machine-readable code, and wherein receiving the authentication challenge associated with the payment may involve scanning, via a camera of the second client device, the machine-readable code displayed on a first client device.

Further, in example embodiments, the authentication challenge may include (iii) information indicating a destination for the client device to transmit the authentication challenge response, and wherein transmitting the authentication challenge response may involve transmitting an authentication challenge response to the indicated destination.

Further yet, in example embodiments, the method may further involve, before receiving the authentication challenge, receiving, via a user interface of the client device, one or more inputs collectively indicating a request to initiate the payment using the payment instrument.

In such an embodiment, the method may further involve, before receiving the authentication challenge: (vii) displaying a selectable option for the user to accept the authentication challenge in association with the payment, wherein the selectable option comprises a discount offer that will be applied to the payment if the user completes the authentication challenge, (viii) receiving, via the user interface, one or more inputs indicating acceptance of the authentication challenge, and (ix) transmitting, to the computing platform associated with the credential verifier, an indication that the authentication challenge has been accepted.

In such an embodiment, the method may further involve (x) after transmitting the authentication challenge response, receiving, from the computing platform associated with the credential verifier, an update to the payment comprising the discount, (xi) receiving, via the user interface, one or more inputs indicating a request to execute the updated payment, and (xii) transmitting, to the computing platform associated with the credential verifier, the request to execute the updated payment to the credential verifier.

Still further, in some example embodiments, the credential issuer is an issuer of the payment instrument, and the method may also involve receiving, from the credential issuer, an indication that the digital credential is available to be associated with the payment instrument, and requesting, from the credential issuer, the digital credential to be associated with the payment instrument.

In yet another aspect, disclosed herein is a computing platform that includes a network interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of one or both of the foregoing methods.

In still another aspect, disclosed herein is a non-transitory computer-readable medium provisioned with program instructions that, when executed by at least one processor, cause a computing platform to carry out the functions disclosed herein, including but not limited to the functions of one or both of the foregoing methods.

One of ordinary skill in the art will appreciate these as well as numerous other aspects in reading the following disclosure.

### BRIEF DESCRIPTION OF THE DRAWINGS

FIG. 1 is an example of a simplified block diagram showing logical entities involved in facilitating a card-not-present payment transaction.

FIG. 2 is an example of a simplified block diagram showing a card-not-present payment transaction using pre-authorization authentication and verification techniques.

FIG. 3 depicts functional block diagram for implementing pre-authorization authentication and verification techniques for an online payment transaction.

FIG. 4 is a functional block diagram that illustrates one example set of functions carried out by a computing platform of a digital credential issuer.

FIG. 5 is a simplified block diagram that illustrates some structural components that may be included in an example computing platform.

FIG. 6 is a simplified block diagram that illustrates some structural components that may be included in an example client device.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

Many types of modern financial transactions are carried out via computing devices and/or computing platforms that are physically remote from each other. For example, in the context of an online payment for goods or services, which may be generally categorized as “e-commerce,” these types of transactions are often referred to as card-not-present transactions. During a card-not-present transaction, neither the payment instrument (e.g., a credit card) nor the holder of the payment instrument (e.g., a consumer) are present with respect to the recipient of the payment (e.g., a merchant). Instead, a consumer may access a merchant's online storefront via a webpage, a mobile application, or the like, and may present credit card information to the merchant electronically.

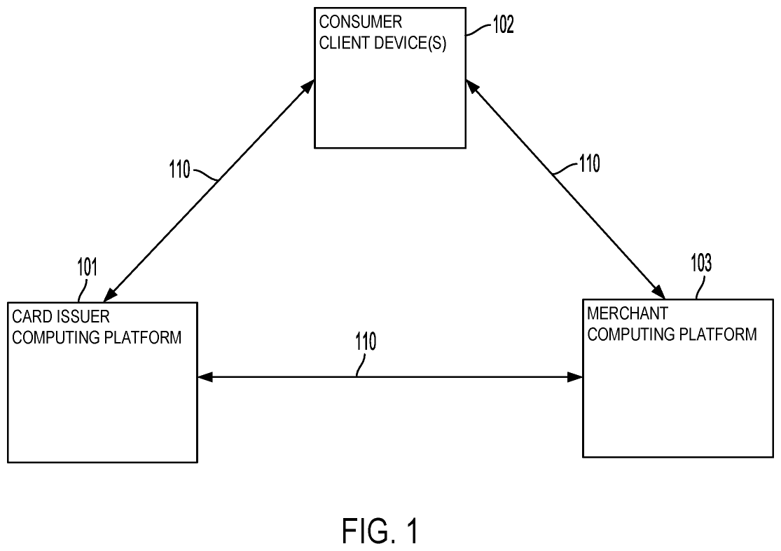

A simplified example of this arrangement is shown in FIG. 1, which depicts a block diagram of the logical entities that may be involved in a typical card-not-present transaction. At a high level, FIG. 1 may generally include a first computing platform 101 that corresponds to a credit card issuer (e.g., a card issuer computing platform 101), one or more client devices 102 that corresponds to a consumer, a second computing platform 103 that corresponds to a merchant (e.g., a merchant computing platform 103), and one or more communication paths 110, each of which may take various forms.

For example, the card issuer computing platform 101 may correspond to a financial institution (e.g., a bank) and may be implemented as a distributed computing platform that includes various software subsystems that are configured to perform a specific card issuer service. For example, a first subsystem of the card issuer computing platform 101 may perform identity verification operations as part of a know-your-customer (KYC) process when a consumer first applies for a new credit card account. A second subsystem of the card issuer computing platform 101 may receive authorization requests (e.g., from merchant computing platform 103) for transactions using a credit card issued by the card issuer and may also verify such authorization requests (e.g., by verifying the requested transaction amount is within a credit limit). Various other card issuer operations, which may be carried out by other subsystems of the card issuer computing platform 101, are also possible.

In a similar way, the merchant computing platform 103 may be implemented as a distributed computing platform that includes various software subsystems that are configured to perform a specific service associated with the merchant's operations. For example, a first subsystem of the merchant computing platform 103 may provide an online shopping cart functionality that may be accessed by client devices (e.g., a consumer client device 102). A second subsystem of the merchant computing platform 103 may generate and transmit authorization requests (e.g., to the card issuer computing platform 101) for transactions using a credit card issued by the card issuer and may receive the authorization verifications. Various other merchant operations, which may be carried out by other subsystems of the merchant computing platform 103, are also possible.

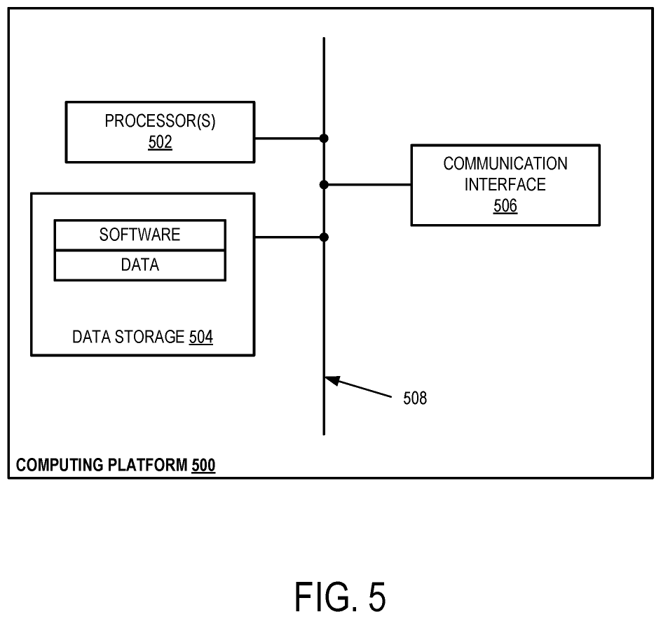

The physical instantiation of the software subsystems included as part of the card issuer computing platform 101 and the merchant computing platform 103 may also take various forms. In this regard, it should be noted that the physical hardware (e.g., servers, processors, communication interfaces, etc.) that makes up the subsystems of either computing platform might not be organized along the same lines as the individual subsystems. For example, a given subsystem may be collectively implemented by two or more physically distinct computing systems. Conversely, a single computing system might implement two or more logically separate subsystems (e.g., within separate containers or virtual machines) using the same physical hardware. Further, each software subsystem may include a network-accessible interface that allows other computing devices, systems, and/or subsystems—both internal and external—to access it over a network. A given subsystem's network-accessible interface may take various forms, such as an application programming interface (API), among other possibilities depending on the implementation. Some of the structural components of the computing systems(s) that might constitute the computing platform 101 or the computing platform 103 are discussed further below in relation to FIG. 5.

The consumer client device(s) 102 shown in FIG. 1 may include one or more devices such as a mobile phone, tablet, desktop or laptop computer, etc. that a consumer may utilize to initiate and complete an online purchase. For example, a consumer client device 102 may access an online storefront provided by the merchant computing platform 103 and initiate a purchase by providing credit card information for a card that was issued by the card issuer computing platform 101. Other examples are also possible.

The example communication paths 110 shown in FIG. 1 may include any one or more of point-to-point links, data networks such as Personal Area Networks (PANs), Local-Area Networks (LANs), Wide-Area Networks (WANs) such as the Internet or cellular networks, cloud networks, and/or operational technology (OT) networks, among other possibilities. In the context of the payment transactions discussed herein, the one or more data networks and/or communication links that make up a given communication path 110 may include a payment network or a payment rail. In some cases, a given payment network or payment rail may take the form on an intermediate system within a given communication path 110. Further, the communication networks and/or links that make up each respective communication path 110 may be wireless, wired, or some combination thereof, and may carry data according to any of various different communication protocols.

In practice, various other logical entities may be involved in the example diagram shown in FIG. 1, such as additional financial institutions (e.g., an acquiring bank), and/or a credit card processing network, among others. In some cases, one or more of these additional logical entities might represent separate subsystems of the card issuer computing platform 101 or the merchant computing platform 103. Numerous other examples are also possible.

Although the types of card-not-present payment transactions that are enabled by the arrangement shown in FIG. 1 may provide a high degree of convenience for card issuers, consumers, and merchants, they also introduce increased opportunities for fraud, which is both easier to undertake and harder to combat in an e-commerce setting. For example, anonymous fraudsters can initiate transactions using stolen credit card information, sometimes in conjunction with associated consumer information that is also stolen such as names, addresses, account usernames and passwords, etc. Because it is difficult to validate the authenticity of a payment and/or the identity of a consumer at the time of a card-not-present transaction, e-commerce fraud associated with such transactions has become a pervasive problem. Moreover, e-commerce fraud can be implemented using a host of different tactics (e.g., card cracking, chargeback fraud, refund fraud, account takeover fraud, interception fraud, triangulation fraud, etc.), and measures put in place to prevent one type of fraud might not prevent other types.

In general, the risks associated with e-commerce fraud primarily fall on merchants, who tend to bear the responsibility for any resulting economic losses. However, credit card issuers (e.g., financial institutions such as banks, etc.) may also incur costs resulting from e-commerce fraud. These may include costs associated with preventative fraud monitoring, processing failed authorization transactions, investigating and resolving disputed transactions, and the cancellation and/or re-issue of compromised credit cards, to name just a few. In addition, there may be some situations in which a merchant may have the ability to shift the liability for economic losses associated with a fraudulent transaction to the credit card issuer, as discussed further below. E-commerce fraud associated with card-not-present transactions has numerous other negative effects on both merchants and card issuers.

Further, although consumers typically do not bear direct responsibility for any economic losses that result from e-commerce fraud, they may nonetheless be confronted with its negative effects as well. For instance, consumers may be forced to dispute fraudulent credit card charges that were undetected by either the merchant or card issuer, which may be a time-consuming process that requires the careful review of monthly credit card statements. In addition, when compromised credit cards are cancelled or reissued, consumers may be forced to update previously-established payment relationships, which can also be a painstaking process. In some situations, a consumer's legitimate transaction using an uncompromised credit card might be denied because either the merchant or the card issuer flagged the transaction as potentially fraudulent during an authorization process, which can lead to consumer frustration.

Because of these problems, card issuers and merchants have tried to implement various measures to combat e-commerce fraud associated with card-not-present transactions. For example, many card issuers deploy predictive analytics (e.g., using one or more machine-learning models) that are applied at the time of authorization to estimate, based on the transaction information, the likelihood that a given transaction is fraudulent. While these predictive fraud models can be somewhat accurate, they are not perfect and can still produce both false positive and false negative predictions. Moreover, they are costly to develop and are generally not used by merchants for this reason.

As another example, some merchants, in cooperation with card issuers, have implemented additional security measures by which a consumer may be challenged by the card issuer directly with an additional authentication before authorization of an online transaction, such as a card issuer password entry field or an out-of-band authentication via a card issuer mobile application. Advantageously for merchants, these types of security measures (e.g., 3D Secure protocol) are one way that the merchant can shift fraud liability for disputed transactions to the card issuer. However, there are also various associated drawbacks. For instance, these measures generally require that a merchant pay fees to implement the service (e.g., monthly fees, per transaction fees, etc.), which in some cases may outweigh the benefits of fraud prevention. Further, these measures also generally require additional connectivity from the merchant back to the card issuer in order to facilitate the additional security challenge. Still further, some of these types of security measures add additional steps, or “friction,” to the consumer's payment experience, which can lead to abandoned purchases and lost sales.

In view of these and other shortcomings surrounding existing measures to reduce e-commerce fraud associated with card-not-present transactions, disclosed herein are new techniques that involve applying pre-authorization authentication and consumer identity verification measures to an online payment transaction. This type of authentication and identity verification may be carried out through the use of a digital trust credential (DTC) that is issued to the consumer by the card issuer in association with the consumer's credit card (making the card issuer a credential issuer as well). The DTC contains a decentralized identifier for the card issuer and a digitally signed attestation by the card issuer as to the identity of the consumer, which the card issuer can make based on the mandatory KYC processing that it undertook in connection with issuing the credit card. The DTC may then be stored in a digital wallet on a consumer client device such that the consumer can elect to present the DTC to a merchant during a card-not-present transaction. In turn, the merchant can use the decentralized identifier to obtain the card issuer's public key from a public registry (e.g., a distributed ledger), thereby enabling the merchant to use a cryptographic proof to verify the digital signature, and along with it the attestation about the consumer in the DTC. In this way, the consumer can effectively transfer the card issuer's trust regarding the identity of the consumer to the merchant in a cryptographically verifiable form.

Further, although the techniques discussed herein may involve one or more additional software utilities that must be installed and/or additional steps that must be performed, various mutually beneficial incentives may be implemented to promote participation in these types of trusted purchasing behaviors. The incentives may take various forms and are discussed in further detail in the examples below.

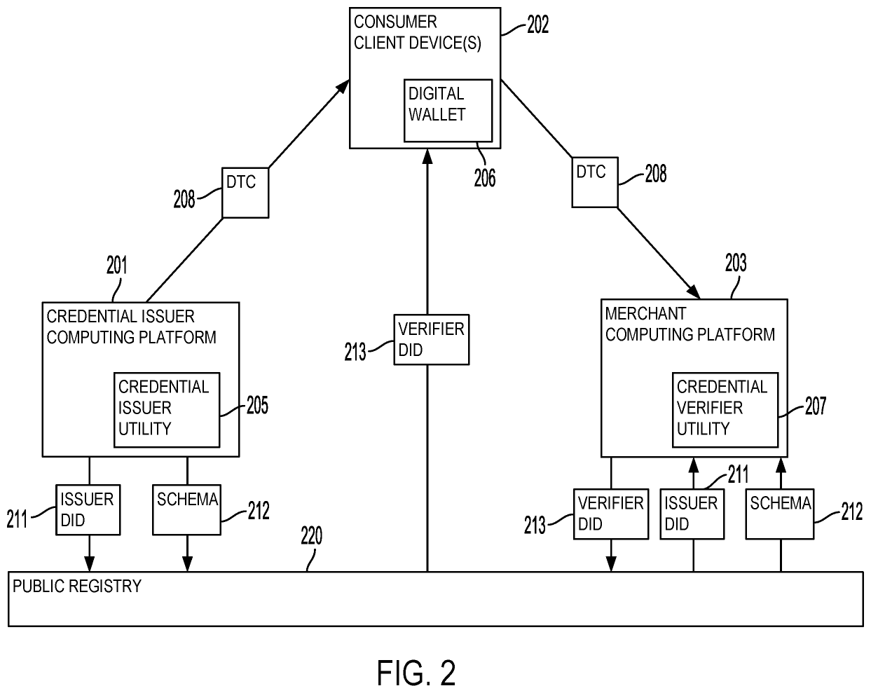

Turning to FIG. 2, a simplified block diagram is shown that depicts a card-not-present payment transaction within an ecosystem that utilizes the disclosed pre-authorization authentication and verification techniques, and will provide the basis to discuss various example implementations associated therewith. For instance, in the examples that follow, the credential issuer computing platform 201 shown in FIG. 2 may correspond to the card issuer computing platform 101 shown in FIG. 1. In particular, the credential issuer of the DTC may be the same entity as the card issuer, as noted above. However, other examples will also be discussed in which the card issuer and credential issuer may be separate entities. In either case, the credential issuer computing platform 201 may include a credential issuer utility 205, as shown in FIG. 2. The credential issuer utility 205 may take the form of a software application, a microservice, or some other logical subsystem of the credential issuer computing platform 201 that may perform one or more of the credential issuer operations discussed herein.

The one or more consumer client device(s) 202 in FIG. 2 may correspond to the client device(s) 102 shown in FIG. 1. As noted above, the client device(s) 202 may represent one or more computing devices (e.g., smartphones, personal computers, etc.) that are associated with the consumer, who may also be referred to as the “holder” of the DTC in the context of FIG. 2. Further, one or more of the client devices 202 may include a digital wallet 206, which may take the form of a software application or the like that is used to store the DTC once it is received from the credential issuer computing platform 201.

Similarly, the merchant computing platform 203 may correspond to the merchant computing platform 103 shown in FIG. 1. In the context of FIG. 2, the merchant may also be referred to as the “verifier” of the DTC. Similar to the credential issuer, the merchant computing platform 203 may include a credential verifier utility 207, as shown in FIG. 2. As above, the credential verifier utility 207 may take the form of a software application, a microservice, or some other subsystem of the merchant computing platform 203 that may perform one or more of the merchant operations discussed herein.

In order to implement the ecosystem shown in FIG. 2, the credential issuer computing platform 201 may generate a globally unique, decentralized identifier for the credential issuer. A decentralized identifier of this kind, or DID, is a character string (e.g., an alpha-numeric character string) that can be used as a uniform resource indicator (URI) that associates a DID subject—here, the credential issuer—to a publicly available DID document that may include cryptographic material (e.g., a public key) as well as other information indicating how to interact with the DID subject in a trusted way. For instance, the credential issuer computing platform 201 (e.g., the credential issuer utility 205) may write an issuer DID 211 in the form of a DID document to a public registry 220, as shown in FIG. 2, in order to facilitate such trusted interactions. Accordingly, any entity that obtains an indication of the issuer DID 211 (e.g., the alpha-numeric character string) may look up the issuer DID 211 on the public registry 220, including all of the information associated therein. In this regard, an issuer DID 211 may take various forms, such as a JavaScript Object Notation (.json) file, among other possibilities.

The public registry 220 may take various forms as well. In some examples, the public registry 220 may take the form of a distributed ledger (e.g., blockchain), although many other types of decentralized public registries are also possible, including a decentralized file system or a key event receipt infrastructure (KERI). Other possibilities also exist.

In addition to generating the issuer DID 211, the credential issuer computing platform 201 may also develop a data model schema that will be used with the DTCs that will be issued to consumers. This DTC credential schema may take various forms and may generally include information that verifies the validity of the relationship between the credential issuer and the consumer. For example, the DTC credential schema may include a set of data fields that indicate the consumer's name, the consumer's account number with the credential issuer, the account's duration (e.g., years of membership). In addition, the DTC credential schema may include data fields that indicate information about the user (e.g., age, state of residence) that may be used to validate certain types of purchases that include restrictions, as discussed further below.

As shown in FIG. 2, the credential issuer computing platform 201 may write the DTC credential schema 212 to the public registry 220 along with the issuer DID 211. In this regard, the DTC credential schema 212 may also be associated with the issuer DID 211 on the public registry 220 such that any entity that obtains an indication of the issuer DID 211 can also use it look up and retrieve the DTC credential schema 212.

Once the issuer DID 211 and the DTC credential schema 212 are established, the credential issuer computing platform 201 may use them to generate a DTC for a consumer. The consumer's DTC, which may also be referred to as a verifiable credential, a decentralized digital credential, or more simply, a digital credential, may be a data object that includes various components. At a minimum, the DTC may include an indication of the issuer DID 211 and one more attestations by the credential issuer about the consumer. The attestations may represent identifying information about the consumer in which the credential issuer has a high degree of trust. For instance, the attestations may take the form of information about the consumer that follows the DTC credential schema 212 developed by the credential issuer. Further, the attestations in the DTC may be digitally signed using a private key of the credential issuer that forms a key pair with the public key associated with the issuer DID 211. The DTC may contain other information as well.

As discussed above, the credential issuer may also be the card issuer. Thus, the credential issuer may obtain trusted information about the consumer through mandatory KYC processing at the time the consumer applies for a new credit card account. This trusted information, perhaps in addition to other trusted information relating to other accounts the consumer has with the credential issuer, may then form the basis for the credential issuer's attestations in a DTC. Accordingly, the credential issuer may offer to issue the consumer a DTC—an identity instrument—that the consumer may use to verify transactions using their credit card—a payment instrument.

Both the credential issuer and the consumer may be incentivized to voluntarily participate in the use of DTCs shown in FIG. 2. From the credential issuer's perspective, the consumer's use of a DTC to authenticate their identity for transactions using their credit card is desirable as a way to reduce the instances of fraud in card-not-present transactions and its associated drawbacks. As discussed further below, merchants may be particularly motivated to encourage consumer use of a DTC in connection with card-not-present transactions, as it presents a way for merchants to both reduce fraud and shift liability for disputed transactions to the credential issuer. As a result, merchants may incentivize consumers to obtain and use DTCs by offering point of sale discounts on card-not-present transactions that are completed using DTC authentication. This, in turn, may drive additional consumer credit card use in lieu of other payment methods—including use of the DTC-associated credit card in lieu of other credit cards—which provides an additional benefit to the credential issuer in the way of increased merchant fee volume. Because of these mutual benefits, the credential issuer might also offer incentives to the consumer in the way of additional loyalty rewards (e.g., credit card points, cash back, etc.) for using a DTC in conjunction with their credit card.

In some implementations, the credential issuer may offer tier levels for DTC loyalty rewards based on the degree of trust the credential issuer has establish with the consumer, with greater degrees of trust corresponding to higher tiers of rewards. Greater degrees of trust may be established based on numerous factors, such as issuer/consumer relationship duration, number of accounts (e.g., deposit accounts, loan accounts, etc.), and/or additional KYC processing, among other possibilities.

As noted above, there may be situations in which the credential issuer is different from the card issuer. For example, a consumer's credit card issuer may not offer a DTC option in association with the issued card. However, the consumer may have one or more other accounts with a different financial institution that does offer a DTC, and which may issue a DTC to the consumer even though it is not associated with a particular card. In these situations, the merchant may still offer the consumer the option of using the DTC (along with a point-of-sale discount), as the credential issuer's attestation is still effective to authenticate the user's identity. However, the credential issuer may not award loyalty rewards in this situation, as the card was issued by a separate entity.

Returning to FIG. 2, upon request from the consumer, the credential issuer computing platform 201 may transmit a DTC 208 to the one or more consumer client devices 202, as shown in FIG. 2. The DTC 208 may then be stored in a digital wallet 206. For example, the consumer may store the DTC 208 in a single digital wallet 206 on their smartphone, which may be the only client device 202 that the consumer uses for presentation of the DTC 208 (e.g., for transactions carried out with other client devices, as discussed below). Alternatively, the consumer may store the DTC 208 in multiple instances of a digital wallet 206 across multiple client devices 202, any of which may be used to present the DTC 208. Other examples are also possible.

Thereafter, when the consumer initiates a card-not-present payment transaction with the merchant computing platform 203, the merchant computing platform 203 may provide an option (e.g., a selectable option on a checkout screen) for the consumer to accept an authentication challenge in association with the payment. If the consumer accepts, the merchant computing platform 203 may cause the authentication challenge to be presented to a client device 202 associated with the consumer. The authentication challenge may take various forms, such as a QR code that may be displayed via a consumer client device 202 that was used to initiate the transaction (e.g., a laptop), and then scanned by a consumer client device 202 that includes the digital wallet 206 (e.g., a smartphone). Alternatively, where the same consumer client device 202 that initiates the transaction also includes the digital wallet 206, the authentication challenge may take other forms, such as a selectable link within the checkout screen, among other possibilities. In some implementations, one or more of the credential issuer computing platform 201, the consumer client device 202, and/or the merchant computing platform 203 may include a web-browser plugin or similar component for interfacing with the digital wallet 206.

Further, the authentication challenge may include various different types of information. For example, the authentication challenge may include a request for credential information that can be used to verify the identity of the consumer—namely, the same type of attested information found in the DTC 208. In addition, the authentication challenge may include an indication where to send an authentication challenge response.

In some implementations, the authentication challenge may include information allows the client device 202 to verify the authenticity of the merchant as the sender of the authentication challenge. In this regard, the authentication challenge may be a data object that is arranged similarly to the DTC 208. For example, the authentication challenge may include an indication of a verifier DID 213 that was previously generated by the merchant computing platform 203 and written to the public registry 220, or perhaps a separate public registry. Further, the request for credential information within the authentication challenge may be digitally signed using the merchant's private key, thereby encrypting the authentication challenge. Accordingly, when the consumer client device 202 receives the data object corresponding to the authentication challenge (e.g., by scanning the QR code), it may use the indication of the verifier DID 213 contained therein to retrieve the merchant's public key from the public registry 220 and use it to decrypt the authentication challenge and cryptographically verify the request for credential information, as well as the identity of the merchant as the sender of the authentication challenge.

In response to the authentication challenge, the consumer client device 202 may transmit an authentication challenge response that includes the DTC 208 to the merchant computing platform 203, as shown in FIG. 2. As discussed above, the merchant computing platform 203 may use the indication of the issuer DID 211 contained in the DTC 208 to retrieve both the issuer's public key and the DTC credential schema 212 from in the public registry 220. The public key is then used to decrypt the attested credential information in the DTC 208. Further, the merchant computing platform 203 may also verify that the credential information in the DTC 208 is consistent with the prescribed DTC credential schema 212.

In some implementations, the merchant computing platform 203 may use the DTC credential schema 212 to identify one or more elements (e.g., a value in a particular data field) of the attested credential information that is required to validate a particular purchase. For example, transactions involving some goods (e.g., alcohol) may only be permitted to consumers older than a certain age. Thus, the merchant may rely on the credential issuer's attestation in the DTC 208 regarding the consumer's age to validate such a transaction.

Various other implementations are also possible, some of which will be discussed in relation to the examples below.

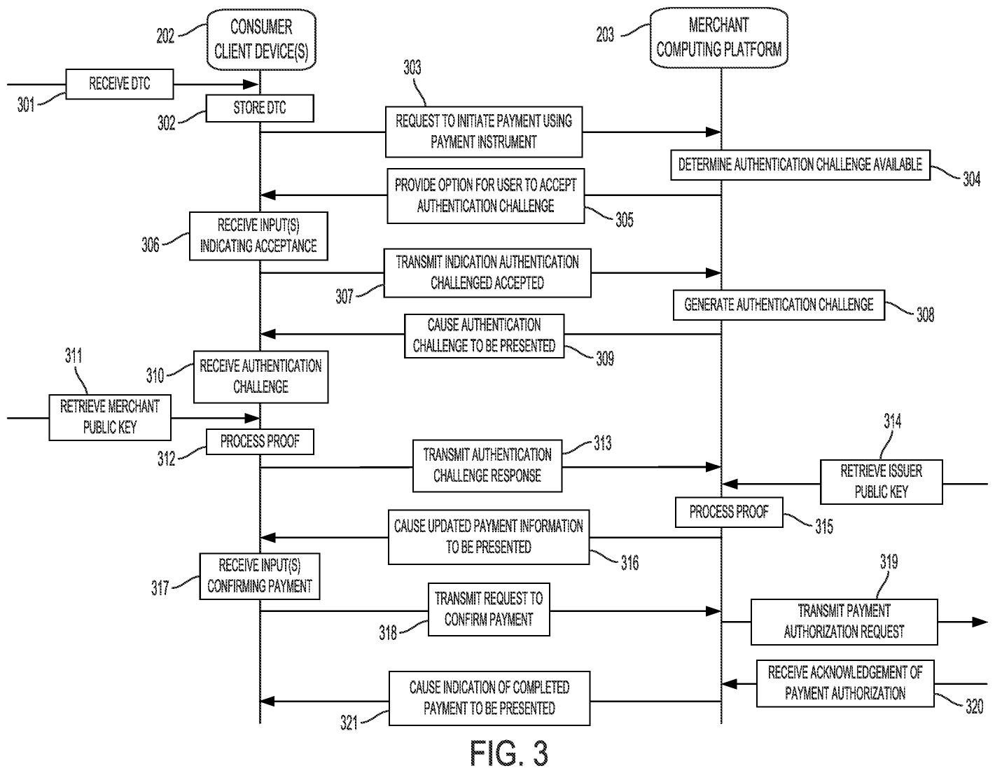

Turning now to FIG. 3, a functional block diagram is shown that depicts example operations for implementing pre-authorization authentication and verification techniques for a card-not-present payment transaction. FIG. 3 includes various communications between one or more consumer client devices 202 (e.g., the consumer client device(s) shown in FIG. 2) and a merchant computing platform 203 (e.g., the merchant computing platform 203 shown in FIG. 2) that may take place during the transaction.

At block 301, the one or more client devices 202 may receive a DTC (e.g., the DTC 208 shown in FIG. 2) from a credential issuer computing platform (e.g., the credential issuer computing platform 201 shown in FIG. 2) that has verified an identify of the consumer associated with the one or more client devices 202. The DTC 208 may include an indication of a decentralized identifier for the credential issuer (e.g., the issuer DID 211 shown in FIG. 2) as well as encrypted credential information indicating the identity of the consumer. As noted above, the credential information may be encrypted using a private key of the credential issuer.

In some situations, the credential issuer may re-issue a DTC to a given consumer if the trusted information conveyed by the DTC changes. For example, a consumer might change their name, or might become more trusted by the credential issuer over time (e.g., by opening more accounts, by completing additional KYC processing, etc.). Similarly, the credential issuer may revoke a DTC for a given customer, as necessary.

At block 302, the one or more consumer client devices 202 may cause the DTC 208 to be maintained in storage on the one or more consumer client devices 202. As discussed above, this may involve storing the DTC 208 in one or more instances of a digital wallet 206. In this regard, a representation of the DTC 208 may be viewable within the digital wallet 206 and may appear as a virtual card or the like. Other visual representations are also possible.

At block 303, the one or more client devices 202 may transmit a request that is received by the merchant computing platform 203 to initiate a card-not-present payment transaction using a payment instrument, such as the credit card associated with the DTC 208. For instance, a consumer client device 202 may receive, via a user interface of the client device 202, one or more inputs selecting a product for purchase and selecting the credit card to make the payment, all of which may collectively indicate the request to initiate the payment.

At block 304, the merchant computing platform 203 may determine that a DTC authentication challenge for the transaction is available. The merchant computing platform 203 may make this determination in various ways. As one possibility, the merchant computing platform 203 may identify the selected payment instrument as a type of credit card (e.g., a credit card issued by a particular financial institution that issues DTCs) that may be associated with a DTC. As another possibility, the merchant computing platform 203 may call an API of the card issuer directly, to query whether a DTC has been issued in association with the card. As yet another possibility, the merchant computing platform 203 may determine that the consumer has updated their account information with the merchant to indicate that the credit card has an associated DTC, and that an option for an authentication challenge should be provided whenever the consumer selection the card for payment. Various other example for how the merchant computing platform 203 may determine the availability of a DTC challenge are also possible.

Still further, in some implementations the merchant computing platform 203 might not undertake any active determination as to whether a DTC challenge is available for a given payment request. Rather, the merchant computing platform may always present an option for the consumer to accept a DTC authentication challenge, thus relying on consumers to indicate that a challenge is available if and when they accept the challenge.

At block 305, the merchant computing platform 203 may provide the option for the consumer to accept an authentication challenge in association with the payment, which may be received by the one or more client devices 202. The option to accept the authentication challenge may take various forms. For instance, the merchant computing platform 203 may cause the one or more client devices 202 to display, via a payment selection page in an online shopping cart, a selectable option for the user to accept the authentication challenge in association with the payment. Further, the option to accept the authentication challenge may be accompanied by an offer for a point-of-sale discount or similar benefit that the merchant computing platform 203 will apply to the transaction if the consumer accepts and successfully completes the authentication challenge. Other examples are also possible.

At block 306, one or more client devices 202 may receive one or more inputs (e.g., a consumer selection of the selectable option) indicating acceptance of the authentication challenge. Accordingly, at block 307, the one or more client devices 202 may transmit an indication that the authentication challenge has been accepted, which may be received by the merchant computing platform 203.

At block 308, based on receiving the indication that the authentication challenge was accepted, the merchant computing platform 203 may generate the authentication challenge. As discussed above, the authentication challenge may include various elements. For instance, the authentication challenge may include an indication of a decentralized identifier for the merchant (e.g., the verifier DID 213 shown in FIG. 2). Further, the authentication challenge may include a request for credential information indicating the identity of the consumer that is encrypted using a private key of the merchant. Still further, in some embodiments the authentication challenge may include an indication of a destination where an authentication challenge response may be transmitted. The authentication challenge may include other elements as well.

At block 309, the merchant computing platform 203 may cause the authentication challenge to be presented to one or more client devices 202. In this regard, the authentication challenge may take various forms. For example, the authentication challenge may be embodied by a machine-readable code, such as a QR code. In this scenario, the authentication challenge may be presented via display on one client device 202 (e.g., a laptop computer) and then received when it is scanned using the camera of another client device 202 (e.g., a smartphone). As another example, where the client device 202 that initiates the payment is the same client device 202 that houses the digital wallet 206, the authentication challenge may be embodied by a selectable link that is displayed as part of the payment screen, among other possibilities. As above, the authentication challenge may be received when the consumer selects the link. The authentication challenge may take other forms as well.

At block 310, the one or more client devices 202 may receive the authentication challenge, as discussed with respect to block 309. Thereafter, the one or more client devices 202 may undertake various operations to validate that the authentication challenge originated from the merchant. For example, the one or more client devices 202 may, at block 311, use the verifier DID to retrieve the merchant's public key from the public registry 220. The one or more client devices 202 may then, at block 312, use the merchant's public key to process the cryptographic proof associated with the digital signature included in the authentication challenge and thereby establish the validity of the request for credential information contained therein. For example, the one or more client devices 202 may use the merchant's public key to decrypt the request for credential information indicating the identity of the consumer.

At block 313, after validating the authentication challenge and the included request for credential information, the client device 202 may transmit an authentication challenge response comprising the DTC 208, which may be received by the merchant computing platform 203. Similar to the validation of the authentication challenge by the one or more client devices 202, the merchant computing platform 203 may undertake various operations to validate the authentication challenge response. However, in the case of the DTC 208, the merchant computing platform 203 is validating that the trusted attestations regarding the consumer contained therein originated from the credential issuer.

For example, the merchant computing platform 203 may, at block 314, use the issuer DID that is contained in the DTC 208 to retrieve the credential issuer's public key from the public registry 220. Alternatively, the issuer DID might indicate a different public registry than the public registry 220 indicated by the verifier DID. In addition, the merchant computing platform 203 may use the issuer DID to retrieve the DTC credential schema 212 from the public registry as well.

At block 315, the merchant computing platform 203 may use the credential issuer's public key to process the cryptographic proof associated with the digital signature included in the DTC 208 and thereby establish the validity of the attestations contained therein. For example, the merchant computing platform 203 may use the credential issuer's public key to decrypt the one or more attestations. In addition, the merchant computing platform 203 may compare the attestations in the DTC 208 with the retrieved DTC credential schema 212 to confirm that the attested information is arranged according to the expected format developed by the credential issuer and indicated in the DTC credential schema 212. In this way, the DTC credential schema 212 may serve as an additional verification that the DTC 208 was not only issued by the credential issuer (i.e., per the issuer DID 211), but that it is also complies with the type of DTC the credential issuer represented that it would issue. For example, if a merchant were to receive a DTC that had a valid issuer DID, but did not match the corresponding DTC credential schema for that issuer, the merchant may opt not to trust the DTC. Other examples are also possible.

Upon validating the attestations regarding the consumer's identity contained within the DTC 208, the merchant thereby gains the trusted knowledge that the consumer associated with the one or more client devices 202 is who they say they are, and that the credit card is the card issued to the consumer. Notably, the merchant gains this level of trust regarding the consumer without any communication with the credential issuer—the source of the trusted information regarding the consumer. Based on this authentication, the merchant computing platform 203 may update information associated with the initiated payment. For example, the merchant computing platform 203 may apply a point-of-sale discount and/or other benefit that was offered to the consumer in conjunction with accepting the authentication challenge.

Alternatively, the merchant might reject the DTC 208. Such a rejection might occur for various reasons. For example, the DTC 208 might contain an indication of an invalid or outdated issuer DID, or the DTC credential schema might not match the schema specified by the issuer of the DTC 208. Still further, other information within the DTC 208 (e.g., the consumer's age, state of residence) may be used by the merchant to determine that the payment transaction should not be completed due to one or more sales restrictions. Numerous other examples are also possible. Whatever the cause of the DTC rejection, the merchant may elect to disallow the payment transaction. Significantly, this determination may be made without any communication (e.g., an authorization request, as discussed below) between the merchant and the credential issuer and/or the card issuer.

Returning to the example of a successful DTC authentication shown in FIG. 3, at block 316, the merchant computing platform 203 may cause the updated payment information to be presented to the one or more client devices 202. For instance, a checkout screen displayed via the one or more client devices 202 may be updated to indicate that the point-of-sale discount and/or other benefit has been applied. Further, the updated payment information may be presented along with a selectable option (e.g., a “Confirm” or “Submit” button) for the consumer to submit a request to the merchant computing platform 203 to confirm the updated payment and complete the transaction.

At block 317, the one or more client devices 202 may receive one or more inputs indicating a request to confirm to the payment. Accordingly, at block 318 the one or more client devices 202 may transmit the request to confirm the payment, which may be received by the merchant computing platform 203.

After receiving the request to confirm the payment from the one or more client devices 202, the merchant computing platform 203 may undertake various operations to execute the payment using the payment instrument. At a high level, this may involve an authorization workflow whereby the merchant computing platform 203 communicates with a card issuer computing platform (e.g., the credential issuer computing platform 201) to authorize the payment.

To facilitate this type of authorization workflow, the merchant computing platform 203 may generate an authorization request (e.g., an ISO 8583 message) that includes various information about the payment transaction. For example, the authorization request may include a payment amount, an identification of the merchant, a date and time, among other information. In addition, the merchant computing platform 203 may include in the authorization request an indication that the DTC authentication challenge was successfully completed, thereby providing the credential issuer with an additional level of trust-based on the DTC and associated attestations that the credential issuer itself provided to the consumer—that the credential issuer may use as a basis to authorize the transaction. The authorization request may include numerous other types of information as well.

At block 319, the merchant computing platform 203 may transmit the payment authorization request, which may be received by the credential issuer computing platform 201. The credential issuer computing platform 201 may verify that the payment is authorized based on some or all of the information included in the authorization request. For example, this type of authorization may involve the credential issuer computing platform 201 confirming that the payment amount does not exceed the card's credit limit, and/or confirming that there is less than a threshold likelihood of fraud associated with the transaction (e.g., based on an analysis of the transaction information using one or more predictive fraud models). In this regard, the credential issuer computing platform 201 may authorize the payment transaction based, at least in part, on the indication in the authorization request that the DTC authentication challenge was successfully completed.

Further, the credential issuer computing platform 201 may update the consumer's loyalty rewards account, as discussed above, based on the indication in the authorization request that the DTC authentication challenge was successfully completed. For instance, the amount of loyalty rewards that are applied may be based on the authorized payment amount. Other examples are also possible.

At block 320, the credential issuer computing platform 201 may transmit an acknowledgement that the payment was authorized, which may be received by the merchant computing platform 203.

At block 321, the merchant computing platform 203 may cause the one or more client devices 202 to display an indication that the payment is complete. For instance, the merchant computing platform 203 may cause the one or more client devices 202 to display a confirmation page and/or a payment receipt that summarizes the details of the transaction. Other possibilities also exist.

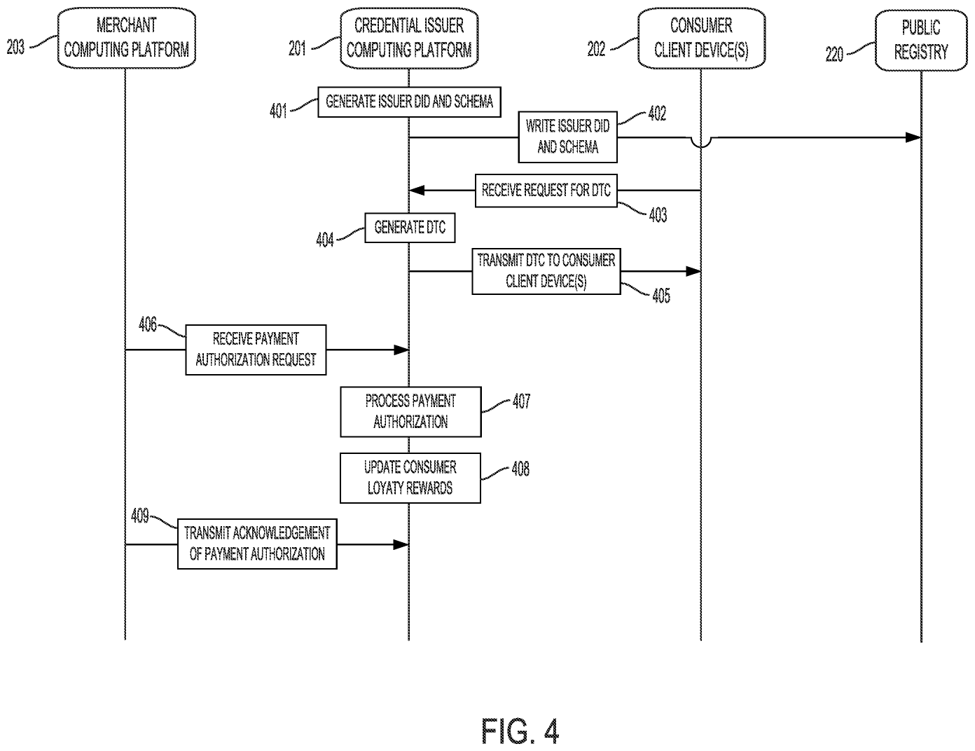

Turning to FIG. 4, another functional block diagram is shown that depicts example operations for implementing pre-authorization authentication and verification techniques for a card-not-present payment transaction. At a high level, FIG. 4 includes various communications and operations that may be carried out by a credential issuer platform (e.g., the credential issuer computing platform 201) during the transaction. In some cases, the communications shown in FIG. 4 may be similar to, or the same as some of the communications shown in FIG. 3 and discussed above, now discussed from the perspective of the credential issuer computing platform 201.

At block 401, the credential issuer computing platform 201 may generate a globally unique decentralized identifier for the credential issuer. Further, the credential issuer computing platform 201 may develop a DTC credential schema that will be used when issuing DTCs to consumers, as discussed above in relation to FIG. 2.

At block 402, the credential issuer computing platform 201 may write the decentralized identifier to a public registry (e.g., the public registry 220) in the form of a DID document (e.g., the issuer DID 211). The credential issuer computing platform 201 may similarly write the DTC credential schema (e.g., the DTC credential schema 212) to the public registry 220. For instance, the issuer DID 211 may be associated with the DTC credential schema 212 and may contain various information for communicating with the credential issuer computing platform 201, such as a public key and one or more service URLs, among other possibilities.

At block 403, the credential issuer computing platform 201 may receive a request for a DTC from one or more consumer client devices 202. As discussed previously, the requesting client device(s) 202 may be associated with a consumer to whom the credential issuer has issued a credit card, and thus the credential issuer computing platform 201 may have already conducted some degree of KYC to verify the identity of the consumer. Accordingly, the credential issuer computing platform 201 may generate a set of one or more attestations regarding the credential issuer's relationship with the consumer, including information about the consumer's identity. Moreover, the credential issuer computing platform 201 may generate the attestations in accordance with the DTC credential schema 212 that was developed for use when generating DTCs.

At block 404, the credential issuer computing platform 201 may generate the DTC. As noted above, the DTC may include an indication of the issuer DID 211 and a digitally signed set of the attestations generated by the credential issuer computing platform 201 relating to the identity of the consumer.

At block 405, the credential issuer computing platform 201 may transmit the DTC (e.g., the DTC 208 shown in FIG. 2) to one or more consumer client devices 202, where it may be stored in one or more instances of a digital wallet 206.

At block 406, the credential issuer computing platform 201 may receive an authorization request message from the merchant computing platform 203. In this regard, and as will be appreciated from the discussion of FIG. 3 above, the credential issuer computing platform 201 might not take any part in a card-not-present payment transaction—including the DTC authentication challenge operations that involve validating the attestations of the credential issuer—until the time of final payment authorization. For this reason, the authorization request from the merchant computing platform 203 may include an indication that the DTC authorization challenge was completed between the consumer and the merchant. If this indication is not provided by the merchant computing platform 203 in the authorization request, the credential issuer computing platform 201 might not have any other way of determining that the challenge was successfully completed.

At block 407, the credential issuer computing platform 201 may process the payment authorization request to verify that the payment is authorized. As discussed above, this may involve the credential issuer computing platform 201 analyzing the transaction details to determine compliance with credit limits, fraud tolerances, and the like.

At block 408, the credential issuer computing platform 201 may update the consumer's loyalty rewards account based on the indication in the authorization message that the DTC authentication challenge was completed.

At block 409, after processing the payment authorization at block 407, the credential issuer computing platform 201 may transmit an acknowledgement message to the merchant computing platform 203 indicating that the payment is authorized.

FIGS. 3-4 include one or more operations, functions, or actions as illustrated by one or more operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

For example, although the DTC-based authentication challenge discussed herein has generally been presented as occurring before a payment transaction is authorized, there may be situations where DTC-based authentication might occur during a payment authorization process. For example, if a payment authorization request is flagged as a fraud risk and/or denied (e.g., by a card issuer, a payment network, etc.) the merchant may present the consumer with a DTC-challenge request if one has not been presented yet. Still further, a merchant might present a DTC-based authentication challenge to a consumer after a payment transaction has been authorized but before a product is shipped. Other examples are also possible.

In addition, for the flowcharts and communication diagrams shown in FIGS. 3-4 and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

Turning now to FIG. 5, a simplified block diagram is provided to illustrate some structural components that may be included in an example computing platform 500. For example, computing platform 500 could serve as the credential issuer computing platform 201 or the merchant computing platform 203 shown in FIG. 2 and may be configured to carry out any of the various computing platform functions disclosed herein—including but not limited to the functions performed by the merchant computing platform 203 in the functional block diagram described with reference to FIG. 3 or the credential issuer computing platform 201 in the functional block diagram described with reference to FIG. 4. At a high level, computing platform 500 may generally comprise any one or more computer systems (e.g., one or more servers) that collectively include at least a processor 502, data storage 504, and a communication interface 506, all of which may be communicatively linked by a communication link 508 that may take the form of a system bus, a communication network such as a public, private, or hybrid cloud, or some other connection mechanism. Each of these components may take various forms.

For instance, processor 502 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 502 could comprise processing components that are distributed across a plurality of physical computing devices connected via a network, such as a computing cluster of a public, private, or hybrid cloud.

In turn, data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, data storage 504 may be capable of storing both (i) program instructions that are executable by processor 502 such that the computing platform 500 is configured to perform any of the various functions disclosed herein, and (ii) data that may be received, derived, or otherwise stored by computing platform 500.

Communication interface 506 may take the form of any one or more interfaces that facilitate communication between computing platform 500 and other systems or devices. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols, among other possibilities.

It should be understood that computing platform 500 is one example of a computing platform that may be used with the embodiments described herein. Numerous other arrangements are possible and contemplated herein. For instance, other computing platforms may include additional components not pictured and/or more or less of the pictured components.

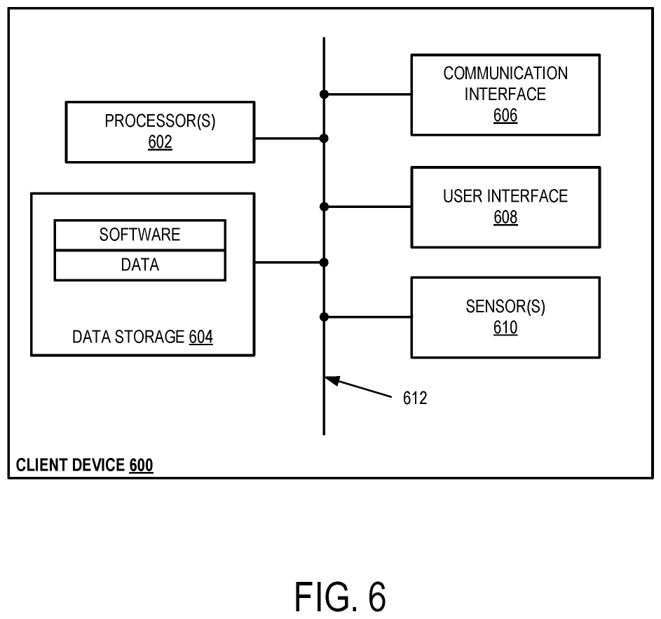

Turning now to FIG. 6, a simplified block diagram is provided to illustrate some structural components that may be included in an example client device 600. For example, client device 600 could serve as one or more of the consumer client devices 202 shown in FIG. 2 and may be configured to carry out any of the various client device functions disclosed herein—including but not limited to the functions performed by the consumer client device(s) 202 in the functional block diagram described with reference to FIG. 3. At a high level, client device 600 may generally comprise a processor 602, data storage 604, a communication interface 606, a user interface 608, one or more sensors 610, all of which may be communicatively linked by a communication link 612 that may take the form of a system bus or some other connection mechanism. Each of these components may take various forms.

For instance, processor 602 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 602 could comprise processing components that are distributed across a plurality of physical computing devices connected via a network, such as a computing cluster of a public, private, or hybrid cloud.

In turn, data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, data storage 604 may be capable of storing both (i) program instructions that are executable by processor 602 such that the client device 600 is configured to perform any of the various functions disclosed herein, and (ii) data that may be received, derived, or otherwise stored by client device 600.

Communication interface 606 may take the form of any one or more interfaces that facilitate communication between client device 600 and other systems or devices. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols (e.g., Bluetooth, near field communications (NFC), ultra-wideband (UWB)), among other possibilities.

The client device 600 may additionally include a user interface 608 for connecting to user-interface components that facilitate user interaction with the client device 600, such as a keyboard, a mouse, a trackpad, a display screen, a touch-sensitive interface, a stylus, a virtual-reality headset, and/or speakers, among other possibilities.

The client device 600 may additionally include one or more sensors 610 for obtaining various different types of data that may facilitate user interaction with the client device 600 or other client device functions, such as a camera, a microphone, and/or a fingerprint sensor, among other possibilities.

It should be understood that client device 600 is one example of a client device that may be used with the embodiments described herein. Numerous other arrangements are possible and contemplated herein.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “consumers,” “holders,” “users” or other entities, this is for purposes of example and explanation only. The claims should not be construed as requiring action by such actors unless explicitly recited in the claim language.

We claim:

1. A client device comprising:
a network interface for communicating over at least one data network;
at least one processor;
at least one non-transitory computer-readable medium; and
program instructions stored on the at least one non-transitory computer-readable medium that are executable by the at least one processor such that the client device is configured to:
receive, from a credential issuer that has verified an identify of a user associated with the client device, a digital credential comprising (i) an identifier for the credential issuer and (ii) encrypted credential information indicating the identity of the user, wherein the credential information is encrypted using a private key of the credential issuer;
cause the digital credential to be maintained in storage on the client device;
receive, from a computing platform associated with a credential verifier, an authentication challenge associated with a payment using a payment instrument, wherein the authentication challenge comprises (i) an identifier for the credential verifier and (ii) an encrypted request for credential information indicating the identity of the user of the payment instrument, wherein the request is encrypted using a private key of the credential verifier;
use the identifier for the credential verifier to obtain a public key of the credential verifier;
use the public key of the credential verifier to decrypt the encrypted request; and
based on the decrypted request, transmit an authentication challenge response comprising the digital credential to the computing platform.

2. The client device of claim 1, wherein the client device is a second client device, wherein the received authentication challenge is embodied by a machine-readable code, and wherein the program instructions that are executable by the at least one processor such that the second client device is configured to receive the authentication challenge associated with the payment comprise program instructions that are executable by the at least one processor such that the client device is configured to scan, via a camera of the second client device, the machine-readable code displayed on a first client device.

3. The client device of claim 1, wherein the authentication challenge further comprises (iii) information indicating a destination for the client device to transmit the authentication challenge response, and wherein the program instructions that are executable by the at least one processor such that the client device is configured to transmit the authentication challenge response comprise program instructions that are executable by the at least one processor such that the client device is configured to transmit an authentication challenge response to the indicated destination.

4. The client device of claim 1, further comprising program instructions that are executable by the at least one processor such that the client device is configured to:
before receiving the authentication challenge, receive, via a user interface of the client device, one or more inputs collectively indicating a request to initiate the payment using the payment instrument.

5. The client device of claim 4, further comprising program instructions that are executable by the at least one processor such that the client device is configured to:
before receiving the authentication challenge:
display a selectable option for the user to accept the authentication challenge in association with the payment, wherein the selectable option comprises a discount offer that will be applied to the payment if the user completes the authentication challenge;
receive, via the user interface, one or more inputs indicating acceptance of the authentication challenge; and
transmit, to the computing platform associated with the credential verifier, an indication that the authentication challenge has been accepted.

6. The client device of claim 5, further comprising program instructions that are executable by the at least one processor such that the client device is configured to:
after transmitting the authentication challenge response, receive, from the computing platform associated with the credential verifier, an update to the payment comprising the discount;
receive, via the user interface, one or more inputs indicating a request to execute the updated payment; and
transmit, to the computing platform associated with the credential verifier, the request to execute the updated payment to the credential verifier.

7. The client device of claim 1, wherein the credential issuer is an issuer of the payment instrument, the client device further comprising program instructions that are executable by the at least one processor such that the client device is configured to:
receive, from the credential issuer, an indication that the digital credential is available to be associated with the payment instrument; and
request, from the credential issuer, the digital credential to be associated with the payment instrument.

8. A non-transitory computer-readable medium, wherein the non-transitory computer-readable medium is provisioned with program instructions that, when executed by at least one processor, cause a client device to:
receive, from a credential issuer that has verified an identify of a user associated with the client device, a digital credential comprising (i) an identifier for the credential issuer and (ii) encrypted credential information indicating the identity of the user, wherein the credential information is encrypted using a private key of the credential issuer;
cause the digital credential to be maintained in storage on the client device;
receive, from a computing platform associated with a credential verifier, an authentication challenge associated with a payment using a payment instrument, wherein the authentication challenge comprises (i) an identifier for the credential verifier and (ii) an encrypted request for credential information indicating the identity of the user of the payment instrument, wherein the request is encrypted using a private key of the credential verifier;
use the identifier for the credential verifier to obtain a public key of the credential verifier;
use the public key of the credential verifier to decrypt the encrypted request; and
based on the decrypted request, transmit an authentication challenge response comprising the digital credential to the computing platform.

9. The non-transitory computer-readable medium of claim 8, wherein the client device is a second client device, wherein the received authentication challenge is embodied by a machine-readable code, and wherein the program instructions that, when executed by at least one processor, cause the second client device to receive the authentication challenge associated with the payment comprise program instructions that, when executed by at least one processor, cause the second client device to scan, via a camera of the second client device, the machine-readable code displayed on a first client device.

10. The non-transitory computer-readable medium of claim 8, wherein the authentication challenge further comprises (iii) information indicating a destination for the client device to transmit the authentication challenge response, and wherein the program instructions that, when executed by at least one processor, cause the client device to transmit the authentication challenge response comprise program instructions that, when executed by at least one processor, cause the client device to transmit an authentication challenge response to the indicated destination.

11. The non-transitory computer-readable medium of claim 8, wherein the non-transitory computer-readable medium is also provisioned with program instructions that, when executed by at least one processor, cause the client device to:
before receiving the authentication challenge, receive, via a user interface of the client device, one or more inputs collectively indicating a request to initiate the payment using the payment instrument.

12. The non-transitory computer-readable medium of claim 11, wherein the non-transitory computer-readable medium is also provisioned with program instructions that, when executed by at least one processor, cause the client device to:
before receiving the authentication challenge:
display a selectable option for the user to accept the authentication challenge in association with the payment, wherein the selectable option comprises a discount offer that will be applied to the payment if the user completes the authentication challenge;
receive, via the user interface, one or more inputs indicating acceptance of the authentication challenge; and
transmit, to the computing platform associated with the credential verifier, an indication that the authentication challenge has been accepted.

13. The non-transitory computer-readable medium of claim 12, wherein the non-transitory computer-readable medium is also provisioned with program instructions that, when executed by at least one processor, cause the client device to:
after transmitting the authentication challenge response, receive, from the computing platform associated with the credential verifier, an update to the payment comprising the discount;
receive, via the user interface, one or more inputs indicating a request to execute the updated payment; and
transmit, to the computing platform associated with the credential verifier, the request to execute the updated payment to the credential verifier.

14. The non-transitory computer-readable medium of claim 8, wherein the credential issuer is an issuer of the payment instrument, and wherein the non-transitory computer-readable medium is also provisioned with program instructions that, when executed by at least one processor, cause the client device to:
receive, from the credential issuer, an indication that the digital credential is available to be associated with the payment instrument; and
request, from the credential issuer, the digital credential to be associated with the payment instrument.

15. A method carried out by a client device, the method comprising:
receiving, from a credential issuer that has verified an identify of a user associated with the client device, a digital credential comprising (i) an identifier for the credential issuer and (ii) encrypted credential information indicating the identity of the user, wherein the credential information is encrypted using a private key of the credential issuer;
causing the digital credential to be maintained in storage on the client device;
receiving, from a computing platform associated with a credential verifier, an authentication challenge associated with a payment using a payment instrument, wherein the authentication challenge comprises (i) an identifier for the credential verifier and (ii) an encrypted request for credential information indicating the identity of the user of the payment instrument, wherein the request is encrypted using a private key of the credential verifier;
using the identifier for the credential verifier to obtain a public key of the credential verifier;
using the public key of the credential verifier to decrypt the encrypted request; and
based on the decrypted request, transmitting an authentication challenge response comprising the digital credential to the computing platform.

16. The method of claim 15, wherein the client device is a second client device, wherein the received authentication challenge is embodied by a machine-readable code, and wherein receiving the authentication challenge associated with the payment comprises scanning, via a camera of the second client device, the machine-readable code displayed on a first client device.

17. The method of claim 15, wherein the authentication challenge further comprises (iii) information indicating a destination for the client device to transmit the authentication challenge response, and wherein transmitting the authentication challenge response comprises transmitting an authentication challenge response to the indicated destination.

18. The method of claim 15, further comprising:
before receiving the authentication challenge, receiving, via a user interface of the client device, one or more inputs collectively indicating a request to initiate the payment using the payment instrument.

19. The method of claim 18, further comprising:
before receiving the authentication challenge:
displaying a selectable option for the user to accept the authentication challenge in association with the payment, wherein the selectable option comprises a discount offer that will be applied to the payment if the user completes the authentication challenge;
receiving, via the user interface, one or more inputs indicating acceptance of the authentication challenge; and
transmitting, to the computing platform associated with the credential verifier, an indication that the authentication challenge has been accepted.

20. The method of claim 19, further comprising:
after transmitting the authentication challenge response, receiving, from the computing platform associated with the credential verifier, an update to the payment comprising the discount;
receiving, via the user interface, one or more inputs indicating a request to execute the updated payment; and
transmitting, to the computing platform associated with the credential verifier, the request to execute the updated payment to the credential verifier.
